(19) United States
(12) Patent Application Publication
(10) Pub. No.: US 2006/0153332 A1
(43) Pub. Date: Jul. 13, 2006

(54) X-ray fluorescence analyzer

(76) Inventors: Hisayuki Kohno, OSAKA (JP); Takashi Shoji, Osaka (JP); Makoto Doi, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/545,612

(22) PCT Filed: Mar. 11, 2004
(86) PCT No.: PCT/JP04/03233

§ 371 Date: Aug. 16, 2005

(30) Foreign Application Priority Data
Mar. 27, 2003 (JP) 2003-086950

(51) Int. Cl. G01T 1/36

(52) U.S. Cl. 378/82

(57) ABSTRACT

A wavelength dispersion type X-ray fluorescence spectrometer, though simple and inexpensive in structure owning to the use of a single X-ray detector, has a capability of measuring the respective intensities of a plurality of secondary X-rays of different wavelengths with a sufficient sensitivity over a wide range. The spectrometer includes an X-ray source (3), a divergence slit (5), an analyzing crystal (7), and a single detector (9), in which a plurality of bent analyzing crystals (7A and 7B), fixedly arranged in a direction, in which the optical paths (6 and 8) of travel of the secondary X-rays spread as viewed from a sample (1) and the detector (9), are used as the analyzing crystal (7) to thereby measure the respective intensities of the plural secondary X-rays (8a and 8b) of the different wavelength.

### FIELD OF THE INVENTION

The present invention relates to a wavelength dispersion type X-ray fluorescence spectrometer capable of measuring respective intensities of a plurality of secondary X-rays of different wavelengths.

### BACKGROUND ART

A simultaneous multielement X-ray fluorescence spectrometer and a sequential X-ray fluorescent spectrometer have hitherto been well known as a wavelength dispersion type X-ray fluorescence spectrometer capable of measuring, with high resolution, respective intensities of a plurality of X-rays of different wavelength such as, for example, fluorescent X-rays and backgrounds thereof or fluorescent X-rays of different wavelengths. The simultaneous multielement X-ray fluorescence spectrometer requires the use of a X-ray detector for each of the secondary X-rays and is, therefore, costly.

On the other hand, the sequential X-ray fluorescence spectrometer makes use of a interlock means such as, for example, a so-called goniometer for driving an analyzing crystal and an X-ray detector relative to each other to change the wavelength of the fluorescent X-rays to be monochromated with the analyzing crystal so that the monochromated fluorescent X-rays can impinge upon an X-ray detector. Although the sequential X-ray fluorescence spectrometer is effective in that with the single X-ray detector the intensity of each of the secondary X-rays can be measured over a relatively wide range of wavelengths, the use of the interlock means, which is generally complicated and requires a high precision, renders the spectrometer to be costly.

In view of those problems, the Japanese Patent No. 2685726 suggests an X-ray fluorescence spectrometer, which does not require the use of any interlock means. Specifically, the X-ray fluorescence spectrometer disclosed therein is so designed and so structured that a single analyzing crystal is utilized to analyze the fluorescent X-rays and backgrounds thereof and two light receiving slits are disposed in front of a single X-ray detector in an adjoining relation with each other so that, while the monochromated beams are focused on those light receiving slits, those slits can be alternately opened to allow the single X-ray detector to measure the respective intensities of the fluorescent X-rays one at a time, with no need to drive the analyzing crystal and the detector in conjunction with each other for sequential operation.

The X-ray fluorescence spectrometer disclosed in the above mentioned patent can be manufactured easily and inexpensively. However, since only one bent analyzing crystal fixed in position is employed in that X-ray fluorescence spectrometer, the respective intensities of the fluorescent X-rays cannot be measured unless the wavelengths of those fluorescent X-rays adjoin to each other (i.e., unless the difference in angle of diffraction (a so-called 20) between those wavelengths is equal or less than 1°) such as observed with the fluorescent X-rays, emitted from heavy elements, and the backgrounds thereof.

An improved version of the X-ray fluorescence spectrometer is suggested in the Japanese Laid-open Patent Publication No. 8-201320. The X-ray fluorescence spectrometer disclosed therein makes use of two bent analyzing crystals for monochromating the fluorescent X-rays and the backgrounds thereof, respectively. More specifically, with this X-ray fluorescence spectrometer, the beams having been monochromated with the respective bent analyzing crystals are focused on two light receiving slits disposed in front of a single X-ray detector in an adjoining relation to each other and those slits are then alternately opened to allow the single X-ray detector to measure the respective intensities of the fluorescent X-rays one at a time, with no need to drive the analyzing crystals and the detector in conjunction with each other for sequential operation.

This X-ray fluorescence spectrometer disclosed in the above mentioned patent publication can be manufactured easily and inexpensively and can also be used to measure the respective intensities of the fluorescent X-rays, emitted from ultralight elements such as, for example, nitrogen, and the backgrounds thereof, even though the wavelength of the fluorescent X-rays may vary to an extent approximating to that of the backgrounds thereof.

The X-ray fluorescence spectrometer disclosed in the above mentioned patent publication utilizes, as spectroscopy, a so-called focusing method in which secondary X-rays emitted from a sample and subsequently diverged are monochromated and condensed with the bent analyzing crystals. It has, however, been found that since those two bent analyzing crystals are fixed in position one behind the other in a direction conforming to the direction of thickness thereof, a portion of the reflective surface of one of the bent analyzing crystals, which is positioned behind the other of the bent analyzing crystals as viewed from the sample and the X-ray detector tends to fall in the shadow of the other of the bent analyzing crystals, with the outer bent analyzing crystal consequently failing to achieve a sufficient measurement of the intensity of the secondary X-rays to be monochromated thereby. If the outer bent analyzing crystal is kept a substantial distance away from the inner bent analyzing crystal, the angle of incidence of the secondary X-rays will increase too much, there is a possibility that no bent analyzing crystal cannot be prepared, which has a lattice space required to monochromate the secondary X-rays of a desired wavelength.

### DISCLOSURE OF THE INVENTION

The present invention has been devised in view of the foregoing problems and inconveniences inherent in the conventional X-ray fluorescence spectrometer and is intended to provide a wavelength dispersion type X-ray fluorescence spectrometer, which makes use of a single X-ray detector and is therefore simple and inexpensive in structure and which is effective to measure, with a sufficient sensitivity, respective intensities of a plurality of secondary X-rays of different wavelength over a wide range.

In order to accomplish the foregoing object, the present invention in accordance with a first aspect thereof provides an X-ray fluorescence spectrometer which comprises an X-ray source for irradiating a sample with primary X-rays; a divergence slit for diverging secondary X-rays emitted from the sample; an analyzing crystal for monochromating and condensing the secondary X-rays having been diverged as they pass through the divergence slit; and a single detector for measuring an intensity of the secondary X-rays having been monochromated with the analyzing crystal, wherein for the analyzing crystal a plurality of bent analyzing crystals, which are fixed in position and arranged in a direction in which a path of travel of the secondary X-rays spreads as viewed from the sample and the detector, are employed to enable an intensity of each of a plurality of secondary X-rays of different wavelengths to be measured.

In the X-ray fluorescence spectrometer according to this first aspect of the present invention, the analyzing crystals fixed in position in correspondence with the plural secondary X-rays of the different wavelengths are employed and the respective intensities of those secondary X-rays of the different wavelengths can be measured with the single detector with no need to drive the analyzing crystals and the detector in conjunction with each other for sequential operation. Therefore, the X-ray fluorescence spectrometer, even though simple and inexpensive in structure, can measure the respective intensities of the plural secondary X-rays of the different wavelengths over the wide range. Also, while the previously described focusing method is employed as spectroscopy, since the plural bent analyzing crystals are fixedly arranged in a direction in which the optical paths of travel of the secondary X-rays spread as viewed from the sample and the detector, there is no possibility that the reflective surface of one or some of the analyzing crystals may be shadowed by that of the other analyzing crystals and, therefore, the respective intensities of the secondary X-rays of the different wavelengths can be measured with sufficient sensitivity.

The X-ray fluorescence spectrometer provided in accordance with a second aspect of the present invention comprises an X-ray source for irradiating a sample with primary X-rays; a Soller slit for collimating secondary X-rays emitted from the sample; an analyzing crystal for monochromating the secondary X-rays having been collimated with the Soller slit; and a single detector for measuring an intensity of the secondary X-rays having been monochromated with the analyzing crystal, wherein for the Soller slit and the analyzing crystal plural sets of a Soller slit and a flat analyzing crystal, which are fixed in position and arranged in a radial pattern as viewed from the sample, are employed to enable an intensity of each of a plurality of secondary X-rays of different wavelengths to be measured.

In the X-ray fluorescence spectrometer according to this second aspect of the present invention, the analyzing crystals fixed in position in correspondence with the plural secondary X-rays of the different wavelengths are employed and the respective intensities of those secondary X-rays of the different wavelengths can be measured with the single detector with no need to drive the analyzing crystals and the detector in conjunction with each other for sequential operation. Therefore, the X-ray fluorescence spectrometer, even though simple and inexpensive in structure, can measure the respective intensities of the plural secondary X-rays of the different wavelengths over the wide range. Also, since as spectroscopy, a so-called parallel beam method is employed, in which the secondary X-rays emitted from the sample and subsequently collimated with the Soller slit are monochromated with the flat analyzing crystal keeping collimated condition, and since plural sets of the Soller slit and the flat analyzing crystal are fixedly arranged in the radial pattern as viewed from the sample, there is no possibility that the reflective surface of one or some of the analyzing crystals may be shadowed by that of the other analyzing crystals and, therefore, the respective intensities of the secondary X-rays of the different wavelengths can be measured with sufficient sensitivity.

The present invention also provides, in accordance with a third aspect thereof, an X-ray fluorescence spectrometer, which comprises an X-ray source for irradiating a sample with primary X-rays; an analyzing crystal for monochromating the secondary X-rays emitted from the sample; and a single detector for measuring an intensity of the secondary X-rays having been monochromated with the analyzing crystal, wherein a single analyzing crystal is employed for the analyzing crystal, and an analyzing crystal drive means is provided to selectively move the analyzing crystal to one of a plurality of predetermined positions to enable an intensity of each of a plurality of secondary X-rays of different wavelengths to be measured.

In this X-ray fluorescence spectrometer according to the third aspect of the present invention, since the analyzing crystal is selectively moved to one of a plurality of positions associated with the plural secondary X-rays of the different wavelengths and, therefore, the respective intensities of those secondary X-rays of the different wavelengths can be measured with the single detector with no need to drive the analyzing crystal and the detector in conjunction with each other for sequential operation. Therefore, the X-ray fluorescence spectrometer, even though simple and inexpensive in structure, can measure the respective intensities of the plural secondary X-rays of the different wavelengths over the wide range. Also, since the single analyzing crystal is employed regardless of whether spectroscopy is a focusing method or a parallel beam method, there is no possibility that the reflective surface of one or some of the analyzing crystals may be shadowed by that of the other analyzing crystals and, therefore, the respective intensities of the secondary X-rays of the different wavelengths can be measured with sufficient sensitivity.

In the X-ray fluorescence spectrometer according to any one of the first to third aspects of the present invention, the mechanism for selecting the secondary X-rays that can be employed therein is available in various types. For example, for such mechanism an optical path selecting means for selectively opening one of a plurality of predetermined optical paths from the sample to the detector, along which the secondary X-rays travel may be employed, which enables the plurality of the X-rays of the different wavelengths to selectively fall onto the detector. Alternatively, a position sensitive detector having an incident surface may be employed, which enables the plurality of the secondary X-rays of the different wavelengths to fall onto different positions of the incident surface of the detector. Again alternatively, a detector drive means for selectively moving the detector to one of a plurality of predetermined positions may be employed to enable the plurality of the X-rays of the different wavelengths to selectively fall onto the detector.

Also, in the X-ray fluorescence spectrometer according to any one of the first and second aspects of the present invention, the analyzing crystal preferably includes a plurality of analyzing crystals having the same lattice space and the same shape, so that the structure can be simple in structure and inexpensive. Alternatively, the analyzing crystal may include a plurality of analyzing crystals provided in association with spaced apart sites of the sample for monochromating secondary X-rays of the same wavelengths, so that the secondary X-rays of the same wavelength emitted from the spaced apart sites of the sample can be monochromated by the corresponding analyzing crystals and then fall onto the detector and, accordingly, even if the sample is heterogeneous, the averaged intensity of the secondary X-rays of such wavelength can be obtained.

In the X-ray fluorescence spectrometer according to the third aspect of the present invention, a plurality of positions provided in association with spaced apart sites of the sample for monochromating X-rays of the same wavelength may be employed. According to this feature, since the secondary X-rays of the same wavelength emitted from the spaced apart sites of the sample can be monochromated by the analyzing crystal, then moved to one of the positions associated with the corresponding spaced apart site, and then fall onto the detector and, accordingly, even if the sample is heterogeneous, the averaged intensity of the secondary X-rays of such wavelength can be obtained.

### BRIEF DESCRIPTION OF THE DRAWINGS

FIG. 1 is a schematic diagram showing an X-ray fluorescence spectrometer according to a first preferred embodiment of the present invention, which is also employed in the practice of a focusing method described in connection with a third preferred embodiment of the present invention;

FIG. 2 is a schematic diagram showing a modified form of the X-ray fluorescence spectrometer;

FIG. 3 is a schematic diagram showing another modified form of the X-ray fluorescence spectrometer;

FIG. 4 is a schematic diagram showing a further modified form of the X-ray fluorescence spectrometer according to the first preferred embodiment of the present invention;

FIG. 5 is a schematic diagram showing still further modified forms of the X-ray fluorescence spectrometer according to the first preferred embodiment of the present invention, which is also employed in the practice of the focusing method described in connection with the third preferred embodiment of the present invention;

FIG. 6 is a schematic diagram showing the X-ray fluorescence spectrometer according to a second preferred embodiment of the present invention, which is also employed in the practice of a parallel beam method described in connection with the third preferred embodiment of the present invention; and

FIG. 7 is a schematic diagram showing a modified form of the X-ray fluorescence spectrometer according to the second preferred embodiment of the present invention.

### BEST MODE FOR CARRYING OUT THE INVENTION

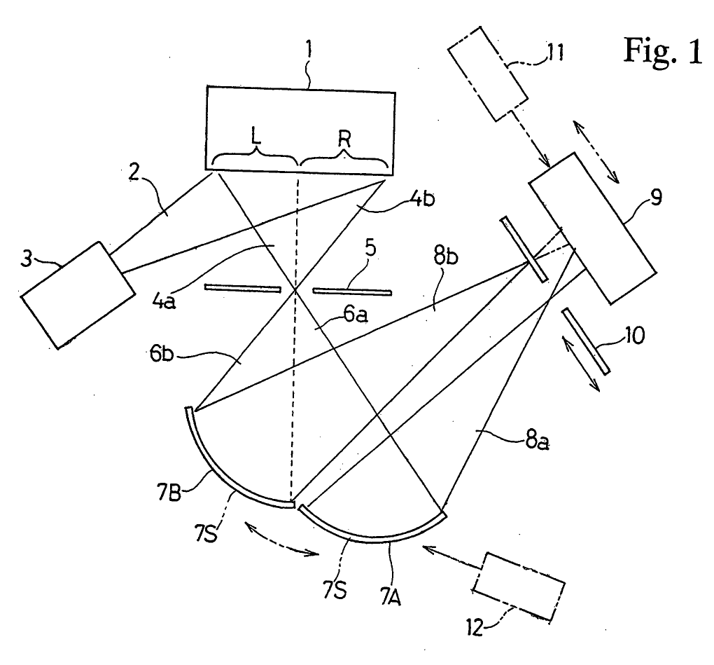

Hereinafter, an X-ray fluorescence spectrometer according to a first preferred embodiment of the present invention will be described with reference to the accompanying drawings. As shown in FIG. 1, the X-ray fluorescence spectrometer includes an X-ray source 3 such as, for example, an X-ray tube for emitting X-rays 2 so as to irradiate a sample 1 placed on a sample support table (not shown), a divergence slit 5 having a rectilinear or dotted slit for diverging secondary X-rays 4, emitted from the sample 1 as they pass through the slit, an analyzing crystal 7 for monochromating and condensing the secondary X-rays 6 which have been diverged by the divergence slit 5, and a single X-ray detector 9 for measuring the intensity of the secondary X-rays 8 which have been monochromated by the analyzing crystal 7. The X-ray detector 9 may be employed in the form of an F-PC (flow proportional counter), S-PC (sealed proportional counter) or SC (scintillation counter).

For the analyzing crystal 7, two bent analyzing crystals 7A and 7B are employed, which are effective to measure respective intensities of two secondary X-rays 8a and 8b of different wavelengths λa and λb. For this purpose, those bent analyzing crystals 7A and 7B are fixed in position in a generally side-by-side relation with each other in a direction in which respective paths of travel of the secondary X-rays 6 and 8 spread as viewed from the sample 1 and the detector 9. Each of the bent analyzing crystals 7A and 7B that can be employed in the present invention may have any suitable shape such as Johann type, Johannson type, logarithmic-spiral type, cylindroid type, spheroid type, cylindrical type or spherical type. Those bent analyzing crystals 7A and 7B may have or may not have respective an identical lattice space (a so-called d value) or an identical shape.

By way of example, the respective intensities of S-Kα line (2θ value: 110.68 degrees) 8a and the background (2θ value: 105.23 degrees) 8b thereof can be measured if a germanium crystal (2d value: 6.53272 Å) is used for each of the bent analyzing crystals 7A and 7B and the latter are bent to the same shape. The use of the bent analyzing crystals 7A and 7B of the same structure makes it possible for the spectrometer to be manufactured simply and inexpensively. Also, the respective intensities of Si-Kα line (2θ value: 109.20 degrees) 8a and Al-Kα line (2θ value: 103.09 degrees) 8b can be measured if PET (2d value: 8.76 Å) and ADP (2d value: 10.648 Å) are used for the bent analyzing crystals 7A and 7B, respectively, and the latter are bent to the same shape. The use of the analyzing crystals 7A and 7B, which are different in lattice space and/or shape can make it possible for the spectrometer to work with the secondary X-rays 8a and 8b of considerably different wavelengths.

As a mechanism for selecting the secondary X-rays 8a and 8b one at a time, an optical path selecting means 10 is employed for selectively opening one of the predetermined optical paths for the secondary X-rays 4, 6 and 8 between the sample 1 to the detector 9, that is, first optical paths 4a, 6a and 8a and second optical paths 4b, 6b and 8b between the sample 1 to the detector 9 so that one of the two secondary X-rays 8a and 8b of different wavelengths can be received selectively by the detector 9.

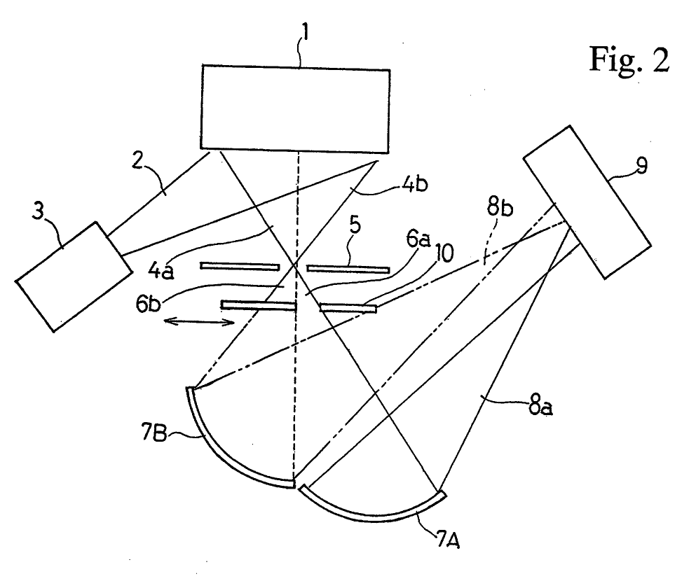

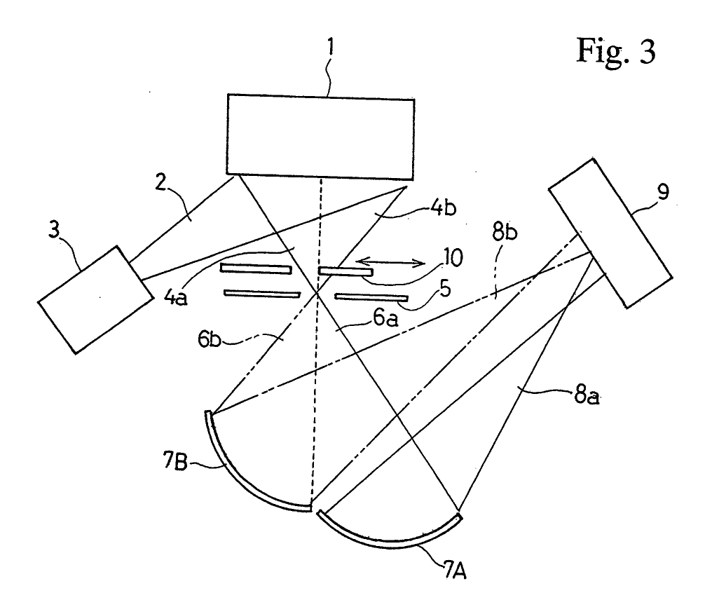

Specifically, the optical path selecting means 10 is comprised of a movable slit 10 having a rectilinear or dotted slit defined therein and adapted be driven between two positions by means of a drive source (not shown) such as, for example, a solenoid, so that when in one position the movable slit 10 can permit the secondary X-rays 8a of a certain wavelength to pass through the slit while when in the other position it can permit the secondary X-rays 8b of a wavelength different from that of the secondary X-rays 8a to pass through the same slit. This movable slit 10 may be disposed forwardly of the X-ray detector 9 as shown in FIG. 1, rearwardly of the divergence slit 5 as shown in FIG. 2 or forwardly of the divergence slit 5 as shown in FIG. 3 (the term “forwardly” is intended to means a position of the optical paths for the secondary X-rays 4, 6 and 8 closer to the sample 1). It is to be noted that in place of the movable slit discussed above, a combination of the slit with shutters may be employed for the optical path selecting means 10, in which case the shutters should be fixedly positioned in alignment with the respective positions to which the slit can be moved selectively, so that one of the secondary X-rays 8a and 8b of the different wavelengths can be selectively passed through the slit when the corresponding shutter is opened.

In place of the optical path selecting means 10, as a mechanism for selecting one of the secondary X-rays 8a and 8b, a detector drive means 11 may be employed, which moves the detector 9 to one of two predetermined positions as shown in FIG. 1 so that one of the two secondary X-rays 8a and 8b of the different wavelength can be selectively received by the detector 9. More specifically, while the detector 9 has an incident surface about the size of the slit in the movable slit referred to above, the detector 9 can be driven to one of the two positions selectively by means of the detector drive means 11 of a simplified structure having a drive source such as a solenoid to select one of the secondary X-rays 8a and 8b in such a way that when the detector 9 is in one position the secondary X-rays 8a of a certain wavelength can be incident on the detector 9 while when the detector 9 is in the other position the secondary X-rays 8b can be incident on the detector 9. It is to be noted that in FIG. 2, FIG. 3 and FIGS. 5 to 7, the detector drive means 11 is not shown.

Also, as a mechanism for selecting one of the secondary X-rays 8a and 8b, in place of the optical path selecting means 10 and the detector drive means 11, the X-ray detector 9 may be employed in the form of a position sensitive X-ray detector, in which case the two secondary X-rays 8a and 8b of the different wavelengths can be sensed at different positions of the incident surface of the X-ray detector 9, respectively. For the position sensitive X-ray detector, any of CCD, PSPC (position sensitive proportional counter), PSSC (position sensitive scintillation counter) and PDA (photodiode array) can be conveniently employed. The use of the position sensitive X-ray detector is particularly advantageous not only in that the spectrometer does not require the use of any movable unit for selecting one of the secondary X-rays 8a and 8b and can therefore be manufactured simple and compact, but also in that since the position sensitive X-ray detector 9 selects one of the two X-rays 8a and 8b in reference to the position of the incident surface where they impinge, the respective intensities of those secondary X-rays 8a and 8b can be measured simultaneously and, therefore, the length of time required to accomplish the measurement can be reduced.

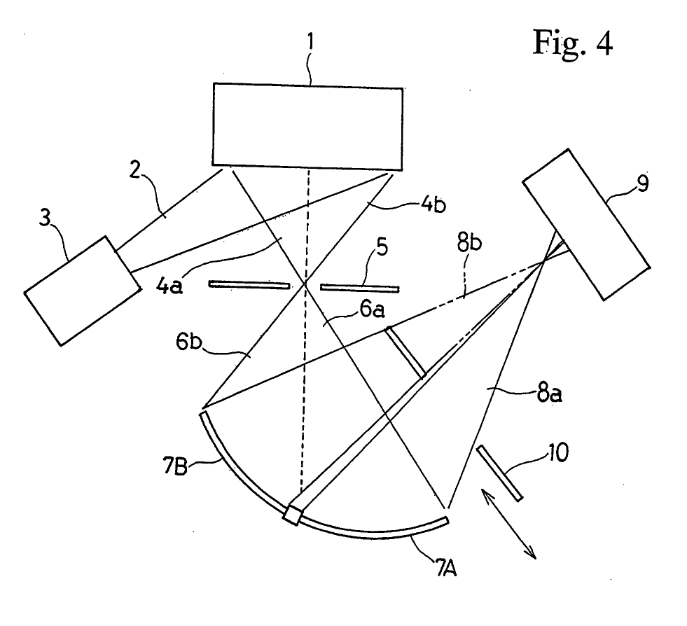

As shown in FIG. 4, if the analyzing crystals 7A and 7B having the same bent shape, but having the different lattice spaces are used, the respective intensities of the secondary X-rays 8a and 8b of the different wavelengths can equally be measured even though those analyzing crystals 7A and 7B are positioned relative to each other as if they were a single bent analyzing crystal, and the space occupied by the bent analyzing crystals 7A and 7B can therefore be minimized. In this case, the two secondary X-rays 8a and 8b of the different wavelengths can be focused on the same position in front of the X-ray detector 9 and, therefore, when it comes to disposition of the optical path selecting means 10 in front of the X-ray detector 9, it will occupy a position adjacent the bent analyzing crystals 7A and 7B rather than the position where the secondary X-rays 8a and 8b are focused. Also, the light receiving slit may be fixedly positioned at the position where the secondary X-rays 8a and 8b are focused.

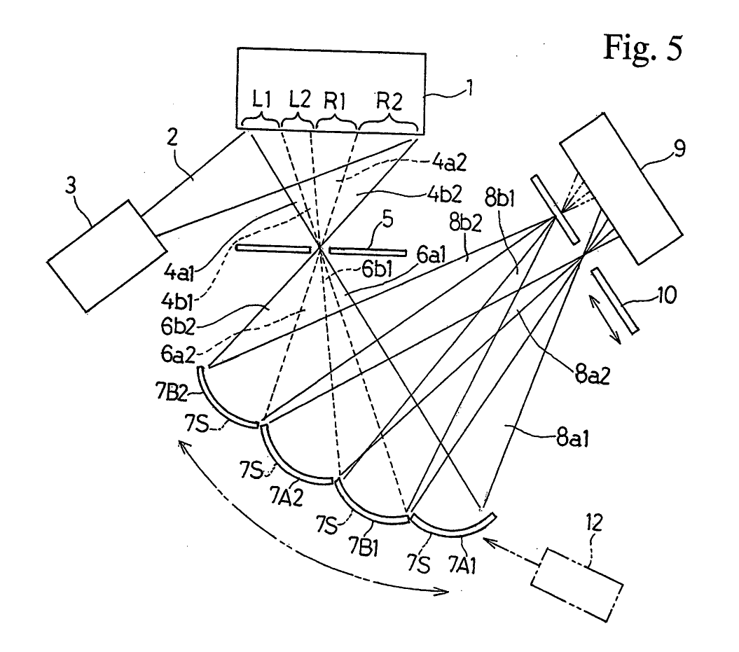

In the structure shown in FIG. 1, the secondary X-rays 8a of the wavelength λa are monochromated by the analyzing crystal 7A associated with a left site L of the sample 1, whereas the secondary X-rays 8b of the wavelength λb are monochromated by the analyzing crystal 7B associated with a right site R of the sample 1. As such, where the sample 1 is heterogeneous in a direction leftwards and rightwards along a surface to be analyzed, the respective intensities of the secondary X-rays 8a and 8b of those wavelengths λa and λb would not be sufficiently accurate for the average value of the sample 1 as a whole. This problem may be setted if the sample 1 is rotated during the measurement, but if the sample 1 cannot be rotated, four analyzing crystals may be employed as shown in FIG. 5. Referring to FIG. 5, those four analyzing crystals include two analyzing crystals 7A1 and 7A2 associated with separate (not neighboring) sites L1 and R1 of the sample 1 for monochromating the secondary X-rays 8a1 and 8a2 of the same wavelength λa, respectively, and two analyzing crystals 7B1 and 7B2 associated with separate different sites L2 and R2 of the same sample 1 for monochromating the secondary X-rays 8b1 and 8b2 of the same wavelength λb, respectively.

According to the construction shown in FIG. 5, the secondary X-rays 8a1 and 8a2 of the wavelength λa emitted from the sites L1 and R1 of the sample 1 spaced leftwards and rightwards are, after having been monochromated by the associated analyzing crystals 7A1 and 7A2, respectively, detected by the X-ray detector 9, whereas the secondary X-rays 8b1 and 8b2 of the wavelength λb emitted from the sites L2 and R2 of the sample 1 spaced leftwards and rightwards are, after having been monochromated by the associated analyzing crystals 7B1 and 7B2, respectively, detected by the X-ray detector 9. Accordingly, even when the sample 1 is heterogeneous in a direction leftwards and rightwards, the averaged intensity of those secondary X-rays 8a and 8b of the respective wavelengths λa and λb can be obtained.

As discussed above, in the X-ray fluorescence spectrometer according to the first embodiment, by the utilization of the analyzing crystals 7A and 7B fixed in position and workable in association with the two secondary X-rays 8a and 8b of the different wavelengths, the respective intensities of those secondary X-rays 8a and 8b can be measured with the single detector 9 with no need to drive the analyzing crystals 7A and 7B and the detector 9 in conjunction with each other for sequential operation. Accordingly, the X-ray fluorescence spectrometer, simple and inexpensive in structure, can be utilized to measure the respective intensities of the two secondary X-rays 8a and 8b of the different wavelengths over the wide range. Also, while the focusing method is used as spectroscopy, since the plural bent analyzing crystals 7A and 7B are fixed in position having been arranged in a direction, in which the respective optical paths of the secondary X-rays 6 and 8 spread as viewed from the sample 1 and the detector 9, the analyzing crystals are not arranged with the reflective surface of one of the analyzing crystals shadowed by that of the other of the analyzing crystals and the two secondary X-rays 8a and 8b of the different wavelengths can be measured with a sufficient sensitivity.

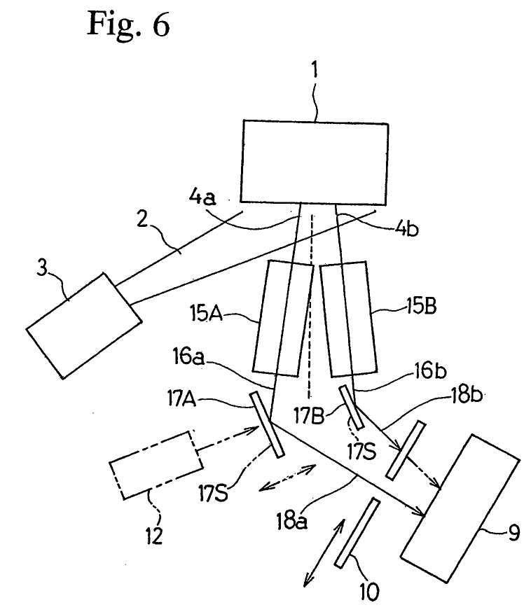

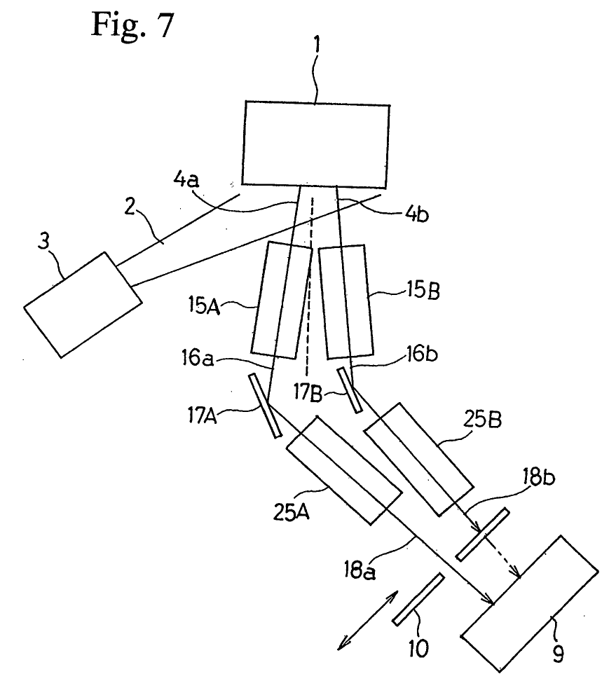

The X-ray fluorescence spectrometer according to a second preferred embodiment will now be described. As shown in FIG. 6, the X-ray fluorescence spectrometer shown therein includes an X-ray source 3 such as, for example, an X-ray tube for emitting X-rays 2 so as to irradiate a sample 1 placed on a sample support table (not shown), a Soller slit 15 for collimating secondary X-rays 4 emitted from the sample 1, an analyzing crystal 17 for monochromating the collimated secondary X-rays 16 which have been collimated by the Soller slit 15 keeping collimated condition, and a single X-ray detector 9 for measuring the intensity of the secondary X-rays 18 which have been monochromated by the analyzing crystal 17. The X-ray detector 9 may be identical with that used in connection with the previously described first embodiment. Also, a similar Soller slit 25 (FIG. 7) may be provided on a light receiving side.

For the Soller slit 15 and the analyzing crystal 17, the use may be made of a set of a Soller slit 15A and a flat analyzing crystal 17A and a set of a Soller slit 15B and a flat analyzing crystal 17B, which are fixed in position having been arranged in a radial pattern as viewed from the sample 1, so that the two secondary X-rays 18a and 18b of the different wavelengths λa and λb can be measured. The two flat analyzing crystals 17A and 17B may have the same grading space or may have different lattice spaces.

By way of example, in a manner similar to the X-ray fluorescence spectrometer according to the previously described first embodiment, the respective intensities of S-Kα line (2θ value: 110.68 degrees) 18a and the background (2θ value: 105.23 degrees) 18b thereof can be measured if a germanium crystal (2d value: 6.53272 Å) is used for each of the flat analyzing crystals 17A and 17B. The use of the flat analyzing crystals 17A and 17B having the same lattice space makes it possible for the spectrometer to be manufactured simply and inexpensively. Also, the respective intensities of Si-Kα line (2θ value: 109.20 degrees) 18a and Al-Kα line (2θ value: 103.09 degrees) 18b can be measured if PET (2d value: 8.76 Å) and ADP (2d value: 10.648 Å), for example, are used for the flat analyzing crystals 17A and 17B, respectively. The use of the analyzing crystals 17A and 17B, which are different in lattice space, can make it possible for the spectrometer to work with the secondary X-rays 18a and 18b of considerably different wavelengths.

As a mechanism for selecting the secondary X-rays 18a and 18b one at a time, other than an optical path selecting means 10, any of a detector drive means 11 (FIG. 1) and a position sensitive X-ray detector 9 can be suitably used as is the case with that in the previously described first embodiment. The position at which the optical path selecting means 10 is provided may be forwardly of the X-ray detector 9, rearwardly of the X-ray detector 9, rearwardly of the Soller slit 15 or forwardly of the Soller slit 15.

Although not shown, but in a manner similar to the previously described first embodiment, if the analyzing crystal 17 includes a plurality of analyzing crystals for monochromating the secondary X-rays of the same wavelength in association with spaced sites of the sample 1, the secondary X-rays of the same wavelength emitted from the spaced sites of the sample can be monochromated by the associated analyzing crystals and then fall onto the X-ray detector 9 and, accordingly, even though the sample 1 is heterogeneous, the averaged intensity of the secondary X-rays of the same wavelength can be obtained.

As discussed above, in the X-ray fluorescence spectrometer according to the second embodiment, by the utilization of the analyzing crystals 17A and 17B fixed in position and workable in association with the two secondary X-rays 18a and 18b of the different wavelengths, the respective intensities of those secondary X-rays 18a and 18b can be measured with the single detector 9 with no need to drive the analyzing crystals 17A and 17B and the detector 9 in conjunction with each other for sequential operation. Accordingly, the X-ray fluorescence spectrometer, simple and inexpensive in structure, can be utilized to measure the respective intensities of the two secondary X-rays 18a and 18b of the different wavelengths over the wide range. Also, while the parallel beam method is used as spectroscopy, since the plural sets of the Soller slit and the flat analyzing crystal 15A and 17A, 15B and 17B are fixed in position having been arranged in a radial pattern as viewed from the sample 1, the analyzing crystals are not arranged with the reflective surface of one of the analyzing crystals shadowed by the other of the analyzing crystals and the two secondary X-rays 18a and 18b of the different wavelengths can be measured with a sufficient sensitivity.

The X-ray fluorescence spectrometer according to a third preferred embodiment of the present invention will now be described. This X-ray fluorescence spectrometer according to a third preferred embodiment of the present invention is such that on the assumption that a plurality of analyzing crystals 7A . . . (FIGS. 1 to 3 and 5) of one kind are employed in the X-ray fluorescence spectrometer according to the previously described first embodiment, in which as spectroscopy the focusing method is employed, in place of the plural analyzing crystals 7A . . . that are fixed in position, a single analyzing crystal 7S is employed and is driven selectively to one of a plurality of positions. By way of example, as shown in FIG. 1, in a manner similar to the previously described first embodiment, the X-ray fluorescence spectrometer includes an X-ray source 3 for irradiating the sample 1 with primary X-rays 2, an analyzing crystal 7 for monochromating secondary X-rays 4 emitted from the sample 1, and a single X-ray detector 9 for measuring the intensity of the secondary X-rays 8 which have been monochromated by the analyzing crystal 7.

It is, however, that for the analyzing crystal 7, a single bent analyzing crystal 7S is employed and an analyzing crystal drive means 12 is provided for selectively moving the analyzing crystal 7S to one of two predetermined positions, that is, the position 7A and the position 7B shown in FIG. 1 so that the respective intensities of the two secondary X-rays 8a and 8b of the different wavelengths can be measured. By way of example, in a manner similar to the X-ray fluorescence spectrometer according to the previously described first embodiment, the respective intensities of S-Kα line (2θ value: 110.68 degrees) 18a and the background (2θ value: 105.23 degrees) 18b thereof can be measured if a germanium crystal (2d value: 6.53272 Å) is used for the bent analyzing crystal 17S. The analyzing crystal drive means 12, when employed in the form of a drive source such as, for example, a solenoid or the like, can be realized with a simplified structure. It is to be noted that in FIGS. 2 and 3, the analyzing crystal drive means 12 is not shown.

As a mechanism for selecting the secondary X-rays 18a and 18b one at a time, other than an optical path selecting means 10, any of a detector drive means 11 and a position sensitive X-ray detector 9 can be suitably used as is the case with that in the previously described first embodiment. If the detector drive means 11 is employed, the analyzing crystal 7S and the X-ray detector 9 appear to be driven in conjunction with each other. However, the fact is that the analyzing crystal 7S and the detector 9 are selectively moved to one of the predetermined positions by one of the analyzing crystal drive means 12 and the detector drive means 11, which are of a simplified structure, but are independent from each other, and the both 7S and 9 are not driven in conjunction with each other for sequential operation. Accordingly, no complicated, highly precise interlock means such as a goniometer generally used in the sequential X-ray fluorescence spectrometer need not be employed in the X-ray fluorescence spectrometer according to this third embodiment. Also, with the X-ray fluorescence spectrometer according to the third embodiment, since the single analyzing crystal 7S is moved for the measurement of the respective intensities of the two secondary X-rays 8a and 8b of the different wavelengths, the respective intensities of the two secondary X-rays 8a and 8b of the different wavelengths cannot be measured simultaneously even if the position sensitive X-ray detector 9 is employed as the mechanism for selecting one of the secondary X-rays 8a and 8b.

In the X-ray fluorescence spectrometer according to the third embodiment, for example, as shown in FIG. 5 the number of the predetermined positions to which the analyzing crystal 7S is selectively moved may be four, including positions 7A1 and 7A2, at which the secondary X-rays 8a1 and 8a2 of the same wavelength λa associated with spaced apart sites L1 and R1 of the sample 1 can be monochromated, and positions 7B1 and 7B2 at which the secondary X-rays 8b1 and 8b2 of the same wavelength λb associated with spaced apart sites L2 and R2 of the sample 1 can be monochromated.

According to the above construction, the secondary X-rays 8a1 and 8a2 of the wavelength λa emitted from the sites L1 and R1 of the sample 1 spaced leftwards and rightwards can be, after having been monochromated by the associated analyzing crystal 7S then moved to the positions 7A1 and 7A2, respectively, detected by the X-ray detector 9, whereas the secondary X-rays 8b1 and 8b2 of the wavelength λb emitted from the sites L2 and R2 of the sample 1 spaced leftwards and rightwards can be, after having been monochromated by the associated analyzing crystals 7B1 and 7B2 then moved to the positions 7B1 and 7B2, respectively, detected by the X-ray detector 9. Accordingly, even when the sample 1 is heterogeneous in a direction leftwards and rightwards, the averaged intensity of those secondary X-rays 8a and 8b of the respective wavelengths λa and λb can be obtained.

The X-ray fluorescence spectrometer according to the third preferred embodiment of the present invention is such that on the assumption that a plurality of analyzing crystals 17A . . . (FIGS. 6 and 7) of one kind are employed in the X-ray fluorescence spectrometer according to the previously described second embodiment, in which as spectroscopy the parallel beam method is employed, in place of the plural analyzing crystals 17A . . . that are fixed in position, a single analyzing crystal 17S is employed and is driven selectively to one of a plurality of positions. By way of example, as shown in FIG. 6, in a manner similar to the previously described second embodiment, the X-ray fluorescence spectrometer includes an X-ray source 3 for irradiating the sample 1 with primary X-rays 1, an analyzing crystal 17 for monochromating secondary X-rays 4 emitted from the sample 1, and a single X-ray detector 9 for measuring the intensity of the secondary X-rays 18 which have been monochromated by the analyzing crystal 17.

It is, however, that for the analyzing crystal 17, a single flat analyzing crystal 17S is employed and an analyzing crystal drive means 12 is provided for selectively moving the analyzing crystal 17S to one of two predetermined positions, that is, the position 17A and the position 17B shown in FIG. 6 so that the respective intensities of the two secondary X-rays 18a and 18b of the different wavelengths can be measured. By way of example, the respective intensities of S-Kα line (2θ value: 110.68 degrees) 8a and the background (2θ value: 105.23 degrees) 18b thereof can be measured if a germanium crystal (2d value: 6.53272 Å) is used for the flat analyzing crystal 17S. As hereinbefore described, the analyzing crystal drive means 12, when employed in the form of a drive source such as, for example, a solenoid or the like, can be realized with a simplified structure. It is to be noted that in FIG. 7, the analyzing crystal drive means 12 is not shown.

As a mechanism for selecting the secondary X-rays 8a and 8b one at a time, a description similar to that described in connection with the focusing method equally applies even where the parallel beam method is employed as spectroscopy. Also, although not shown, if the plural positions to which the analyzing crystal 7S is moved one at a time include a plurality of positions required for the secondary X-rays of the same wavelength can be monochromated in association with the spaced apart sites of the sample, the secondary X-rays of the same wavelength emitted from the spaced apart sites of the sample 1 can, after having been monochromated by the analyzing crystal 7S then moved to the associated position, fall onto the X-ray detector 9. Accordingly, in a manner similar to that described previously in connection with the focusing method, even though the sample 1 is heterogeneous, the averaged intensity of the secondary X-rays of the same wavelength can be obtained.

As discussed above, in the X-ray fluorescence spectrometer according to the third embodiment, by allowing the analyzing crystal 7S to be selectively moved to the positions 7A and 7B or 17A and 17B, which are associated with the two secondary X-rays 8a and 8b or 18a and 18b of the different wavelengths, the respective intensities of those secondary X-rays can be measured with the single detector 9 with no need to drive the analyzing crystal 7S and the detector 9 in conjunction with each other for sequential operation. Accordingly, the X-ray fluorescence spectrometer, simple and inexpensive in structure, can be utilized to measure the respective intensities of the two secondary X-rays 8a and 8b or 18a and 18b of the different wavelengths over the wide range. Also, regardless of whether the focusing method is employed as spectroscopy or whether the parallel beam method is employed as spectroscopy, the single analyzing crystal 7S is employed and, accordingly, the reflective surface of the analyzing crystal is in no way shadowed by the other analyzing crystal and the respective intensities of the two secondary X-rays 8a and 8b or 18a and 18b of the different wavelengths can be measured with a sufficient sensitivity.

It is to be noted that in the foregoing embodiments reference has been made to the two secondary X-rays of the different wavelengths to be measured, the number of the secondary X-rays to be measured may be three or more. In correspondence therewith, the number of the analyzing crystals fixed in position and the positions to which the analyzing crystal is moved one at a time may be three or more. The analyzing crystal fixed in position may include three or more analyzing crystals having the same lattice space and the same shape. Also, the analyzing crystal fixed in position may include three or more analyzing crystals capable of monochromating the secondary X-rays of the same wavelength in association with the spaced apart site of the sample. Similarly, the positions to which the analyzing crystal is moved one at a time may include three or more positions so that the secondary X-rays of the same wavelength can be monochromated in correspondence with the spaced apart sites of the sample.

1. An X-ray fluorescence spectrometer which comprises:
an X-ray source for irradiating a sample with primary X-rays;
a divergence slit for diverging secondary X-rays emitted from the sample;
an analyzing crystal for monochromating and condensing the secondary X-rays having been diverged as they pass through the divergence slit; and
a single detector for measuring an intensity of the secondary X-rays having been monochromated with the analyzing crystal;
wherein for the analyzing crystal a plurality of bent analyzing crystals, which are fixed in position and arranged in a direction in which a path of travel of the secondary X-rays spreads as viewed from the sample and the detector, are employed to enable an intensity of each of a plurality of secondary X-rays of different wavelengths to be measured.

2. An X-ray fluorescence spectrometer which comprises:
an X-ray source for irradiating a sample with primary X-rays;
a Soller slit for collimating secondary X-rays emitted from the sample;
an analyzing crystal for monochromating the secondary X-rays having been collimated with the Soller slit; and
a single detector for measuring an intensity of the secondary X-rays having been monochromated with the analyzing crystal;
wherein for the Soller slit and the analyzing crystal plural sets of a Soller slit and an analyzing crystal, which are fixed in position and arranged in a radial pattern as viewed from the sample, are employed to enable an intensity of each of a plurality of secondary X-rays of different wavelengths to be measured.

3. An X-ray fluorescence spectrometer which comprises:
an X-ray source for irradiating a sample with primary X-rays;
an analyzing crystal for monochromating the secondary X-rays emitted from the sample; and
a single detector for measuring an intensity of the secondary X-rays having been monochromated with the analyzing crystal;
wherein a single analyzing crystal is employed for the analyzing crystal, and an analyzing crystal drive means is provided to selectively move the analyzing crystal to one of a plurality of predetermined positions to enable an intensity of each of a plurality of secondary X-rays of different wavelengths to be measured.

4. The X-ray fluorescence spectrometer as claimed in claim 1, wherein further comprising an optical path selecting means for selectively opening one of a plurality of predetermined optical paths from the sample to the detector, along which the secondary X-rays travel, to enable the plurality of the X-rays of the different wavelengths to selectively fall onto the detector.

5. The X-ray fluorescence spectrometer as claimed in claim 1, wherein the detector is a position sensitive detector having an incident surface and the plurality of the secondary X-rays of the different wavelengths fall onto different positions of the incident surface of the detector.

6. The X-ray fluorescence spectrometer as claimed in claim 1, further comprising a detector drive means for selectively moving the detector to one of a plurality of predetermined positions to enable the plurality of the X-rays of the different wavelengths to selectively fall onto the detector.

7. The X-ray fluorescence spectrometer as claimed in claim 1, wherein the analyzing crystal includes a plurality of analyzing crystals having the same lattice space and the same shape.

8. The X-ray fluorescence spectrometer as claimed in claim 1, wherein the analyzing crystal includes a plurality of analyzing crystals provided in association with spaced apart sites of the sample for monochromating secondary X-rays of the same wavelengths.

9. The X-ray fluorescence spectrometer as claimed in claim 3, wherein the plurality of predetermined positions comprise a plurality of positions provided in association with spaced apart sites of the sample for monochromating X-rays of the same wavelength.

10. The X-ray fluorescence spectrometer as claimed in claim 2, wherein further comprising an optical path selecting means for selectively opening one of a plurality of predetermined optical paths from the sample to the detector, along which the secondary X-rays travel, to enable the plurality of the X-rays of the different wavelengths to selectively fall onto the detector.

11. The X-ray fluorescence spectrometer as claimed in claim 3 wherein further comprising an optical path selecting means for selectively opening one of a plurality of predetermined optical paths from the sample to the detector, along which the secondary X-rays travel, to enable the plurality of the X-rays of the different wavelengths to selectively fall onto the detector.

12. The X-ray fluorescence spectrometer as claimed in claim 2 wherein the detector is a position sensitive detector having an incident surface and the plurality of the secondary X-rays of the different wavelengths fall onto different positions of the incident surface of the detector.

13. The X-ray fluorescence spectrometer as claimed in claim 3, wherein the detector is a position sensitive detector having an incident surface and the plurality of the secondary X-rays of the different wavelengths fall onto different positions of the incident surface of the detector.

14. The X-ray fluorescence spectrometer as claimed in claim 2, further comprising a detector drive means for selectively moving the detector to one of a plurality of predetermined positions to enable the plurality of the X-rays of the different wavelengths to selectively fall onto the detector.

15. The X-ray fluorescence spectrometer as claimed in claim 3, further comprising a detector drive means for selectively moving the detector to one of a plurality of predetermined positions to enable the plurality of the X-rays of the different wavelengths to selectively fall onto the detector.

16. The X-ray fluorescence spectrometer as claimed in claim 2, wherein the analyzing crystal includes a plurality of analyzing crystals having the same lattice space and the same shape.

17. The X-ray fluorescence spectrometer as claimed in claim 2, wherein the analyzing crystal includes a plurality of analyzing crystals provided in association with spaced apart sites of the sample for monochromating secondary X-rays of the same wavelengths.
